(19) United States
(12) Patent Application Publication
(10) Pub. No.: US 2020/0154241 A1
(43) Pub. Date: May 14, 2020

(54) METHODS FOR RELIABLE TRANSMISSION OF A SUPL INIT MESSAGE

(71) Applicant: MEDIATEK INC., Hsinchu City (TW)

(72) Inventors: Rohit NAIK, Hsinchu City (TW); Chien-Chun HUANG-FU, Hsinchu City (TW)

(21) Appl. No.: 16/676,814

(22) Filed: Nov. 7, 2019

Related U.S. Application Data
(60) Provisional application No. 62/757,232, filed on Nov. 8, 2018.

(51) Int. Cl. H04W 4/029; H04W 4/90; H04W 76/50; H04M 1/725; H04M 7/00; H04L 29/06; H04W 12/00; H04W 64/00

(52) U.S. Cl. CPC H04W 4/029; H04W 4/90; H04W 76/50; H04M 1/72536; H04W 64/003; H04L 65/1006; H04L 65/1016; H04W 12/0013; H04L 69/161; H04M 7/0078

(57) ABSTRACT

A method, executed by a SUPL (Secure User Plane Location) Enabled Terminal (SET), is provided. The method includes the steps of: sending an INVITE request for an emergency call to a Call Session Control Function (CSCF) entity of an IP Multimedia Subsystem (IMS); and receiving a response to the INVITE request from the CSCF entity, wherein the response includes an SUPL INIT message.

### CROSS REFERENCE TO RELATED APPLICATIONS

This application claims priority of U.S. Provisional Application No. 62/757,232, filed on Nov. 8, 2018, the entirety of which is incorporated by reference herein.

### BACKGROUND OF THE APPLICATION

### Field of the Application

The application generally relates to mobile communications, and more particularly, to methods for reliable transmission of a SUPL (Secure User Plane Location) INIT message.

### Description of the Related Art

Applications related to Location Based Services (LBS) are becoming more and more popular in today's mobile markets. For mobile subscribers, using LBS-related applications on mobile communication devices requires the user's location to be available as quickly and accurately as possible. Although the Global Positioning System (GPS) has been the main solution to this need for several years, it has its limitations. Generally, GPS works fine in rural areas but often barely works in urban areas or in buildings. Thus, it is commonly proposed to supplement the GPS with assistance and positioning data provided by the networks (also called the Assisted-GPS (A-GPS)). The assistance and positioning data can be exchanged between the mobile communication devices and the networks over either the control plane or the user plane. The control plane implementations may use a dedicated control channel, but they result in significant network overhead due to the software and hardware changes needed for various network components to support the location-specific messages. To this end, the user plane implementations have grown in popularity in recent years for non-critical commercial location applications.

One of the user plane implementations, Secure User Plane Location (SUPL), was developed by the Open Mobile Alliance (OMA) to support the LBS for mobile communications in various cellular technologies, such as Global System for Mobile communications (GSM) technology, General Packet Radio Service (GPRS) technology, Enhanced Data rates for Global Evolution (EDGE) technology, Wideband Code Division Multiple Access (WCDMA) technology, Code Division Multiple Access 2000 (CDMA2000) technology, Time Division-Synchronous Code Division Multiple Access (TD-SCDMA) technology, Worldwide Interoperability for Microwave Access (WiMAX) technology, Long Term Evolution (LTE) technology, Time-Division LTE (TD-LTE) technology, LTE-Advanced (LTE-A) technology, New Radio (NR) technology, etc.

According to the 3GPP Technical Specification (TS) 36.305 and the OMA-AD-SUPL specification, when the network side receives an INVITE request for an emergency call, it should trigger an SUPL session to track the location of the User Equipment (UE), by sending a SUPL INIT message to the UE. However, the SUPL INIT message is sent using unreliable transport, such as using OMA Push, Session Initiation Protocol (SIP) Push, Mobile-Terminated (MT) Short Message Service (SMS), or User Datagram Protocol (UDP). Therefore, the SUPL INIT message may be lost to the UE in various situations where the radio signal quality is poor (e.g., the UE enters an elevator or a basement, or is crossing a cell boundary, or is transitioning to a different Radio Access Technology (RAT)).

### BRIEF SUMMARY OF THE APPLICATION

In order to solve the aforementioned problem, the present application proposes methods for reliable transmission of a SUPL INIT message.

In a first aspect of the application, a method, executed by a SUPL (Secure User Plane Location) Enabled Terminal (SET), is provided. The method comprises the steps of: sending an INVITE request for an emergency call to a Call Session Control Function (CSCF) entity of an IP Multimedia Subsystem (IMS); and receiving a response to the INVITE request from the CSCF entity, wherein the response comprises an SUPL INIT message.

In a second aspect of the application, a method, executed by a CSCF entity of an IMS, is provided. The method comprises the steps of: sending a SUPL INIT message to an SET; starting a timer in response to sending the SUPL INIT message; and resending the SUPL INIT message to the SET in response to the timer being expired and not receiving any Transmission Control Protocol (TCP) or Internet Protocol (IP) connection request from the SET.

In a third aspect of the application, a method, executed by an SET, is provided. The method comprises the steps of: receiving a SUPL INIT message from an SLP; and sending an acknowledgement of the SUPL INIT message to the SLP in response to receiving the SUPL INIT message.

In a fourth aspect of the application, a method, executed by an SET, is provided. The method comprises the steps of: establishing a TCP or IP connection with an SLP; and receiving a SUPL INIT message from the SLP after establishing the TCP or IP connection.

Other aspects and features of the present application will become apparent to those with ordinarily skill in the art upon review of the following descriptions of specific embodiments of the methods for reliable transmission of a SUPL INIT message.

### BRIEF DESCRIPTION OF DRAWINGS

The application can be more fully understood by reading the subsequent detailed description and examples with references made to the accompanying drawings, wherein:

FIG. 1 is a block diagram of a wireless communication environment according to an embodiment of the application;

FIG. 2 is a block diagram illustrating the mobile communication device 110 according to an embodiment of the application;

FIG. 3 is a block diagram illustrating a network entity according to an embodiment of the application;

FIGS. 4A and 4B show a message sequence chart illustrating a method for reliable transmission of a SUPL INIT message according to an embodiment of the application;

FIG. 5 is a message sequence chart illustrating a method for reliable transmission of a SUPL INIT message according to another embodiment of the application;

FIG. 6 is a message sequence chart illustrating a method for reliable transmission of a SUPL INIT message according to another embodiment of the application; and

FIG. 7 is a message sequence chart illustrating a method for reliable transmission of a SUPL INIT message according to another embodiment of the application.

### DETAILED DESCRIPTION OF THE APPLICATION

The following description is made for the purpose of illustrating the general principles of the application and should not be taken in a limiting sense. It should be understood that the embodiments may be realized in software, hardware, firmware, or any combination thereof. The terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

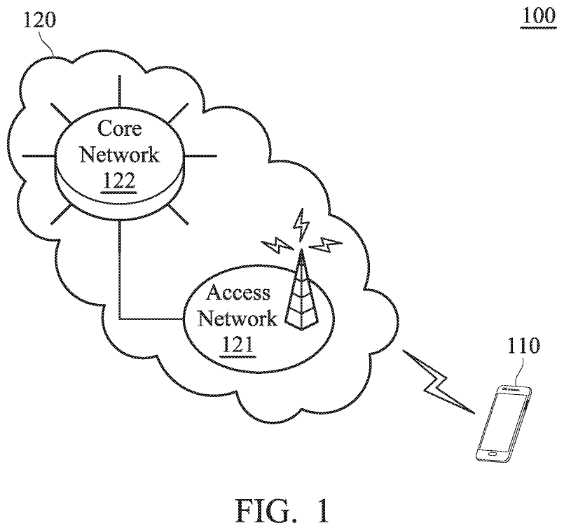

FIG. 1 is a block diagram of a wireless communication environment according to an embodiment of the application.

As shown in FIG. 1, the wireless communication environment 100 may include a mobile communication device 110 and a service network 120, wherein the mobile communication device 110 may be wirelessly connected to the service network 120 for obtaining mobile services, including emergency call service and Location Based Service (LBS).

The mobile communication device 110 may be a feature phone, a smartphone, a panel Personal Computer (PC), a laptop computer, or any wireless communication device supporting the cellular technology utilized by the service network 120. The mobile communication device 110 may be referred to as a User Equipment (UE), a Mobile Station (MS), or a SUPL Enabled Terminal (SET), depending on its role in different signaling procedures, such as NAS signaling procedures, or IP Multimedia Subsystem (IMS) procedures, or Location Service (LCS) procedures.

The service network 120 may include an access network 121 and a core network 122. The access network 121 is responsible for processing radio signals, terminating radio protocols, and connecting the mobile communication device 110 with the core network 122. The core network 122 is responsible for performing mobility management, network-side authentication, and interfaces with public/external networks (e.g., the Internet). Specifically, the access network 121 and the core network 122 may each include one or more network nodes for carrying out said functions.

In one embodiment, the service network 120 may be an LTE/LTE-A/TD-LTE network, and correspondingly, the access network 121 may be an Evolved-Universal Terrestrial Radio Access Network (E-UTRAN), and the core network 122 may be an Evolved Packet Core (EPC).

An E-UTRAN may include one or more evolved NodeBs (eNBs), wherein each eNB may be a macro eNB, femto eNB, or pico eNB, and may be referred to as a 4G cellular station. Each 4G cellular station may form at least one cell to provide the function of wireless transmission and reception to and from the mobile communication device 110.

An EPC may include a Home Subscriber Server (HSS), a Mobility Management Entity (MME), a Serving Gateway (S-GW), a Packet Data Network Gateway (PDN-GW or P-GW), an IMS, and an LCS server.

The HSS is a master user database that supports the IMS entities that actually handle calls. It contains the subscription-related information (subscriber profiles), performs authentication and authorization of the user, and can provide information about the subscriber's location and IP information.

The MME is responsible for managing session states, UE authentication, UE paging, UE mobility, UE roaming, and other bearer management functions.

The S-GW is responsible for routing and forwarding user data packets, while also acting as the mobility anchor for the user plane during inter-eNB handovers and as the anchor for mobility between LTE and other cellular technologies.

The P-GW is responsible for providing connectivity from the mobile communication device 110 to external packet data networks by being the point of exit and entry of traffic for the mobile communication device 110.

The IMS is responsible for providing IP multimedia services, such as Voice over LTE (VoLTE) call services for both normal calls and emergency calls. One of the key nodes of the IMS is the Call Session Control Function (CSCF) entity which serves as an SIP server for processing SIP signaling and is further divided into three categories: Proxy-CSCF (P-CSCF), Interrogating-CSCF (I-CSCF), and Serving-CSCF (S-CSCF). P-CSCF plays the role as a proxy server to be queried by a remote SIP entity, for example, during session set up. I-CSCF interrogates the HSS to obtain the address of the relevant S-CSCF to process the SIP initiation request. S-CSCF is a SIP server with a key responsibility as the SIP registration server, and it also provides translation services for SIP routing when a telephone number is dialed.

The LCS server may include a SUPL Location Platform (SLP), and an Evolved Serving Mobile Location Center (E-SMLC). The SLP is the Entity responsible for SUPL Service Management and Position Determination in the SUPL specification. The E-SMLC manages the overall coordination and scheduling of resources required for the location determination of a UE (e.g., the mobile communication device 110) that is attached to the E-UTRAN.

In another embodiment, the service network 120 may be a 5G NR network, and the access network 121 and the core network 122 may be a Next Generation-Radio Access Network (NG-RAN) and a Next Generation-Core Network (NG-CN), respectively.

ANG-RAN may include one or more next generation NodeBs (gNBs), which support high frequency bands (e.g., above 24 GHz), and each gNB may further include one or more Transmission Reception Points (TRPs), wherein each gNB or TRP may be referred to as a 5G cellular station. Some gNB functions may be distributed across different TRPs, while others may be centralized, leaving the flexibility and scope of specific deployments to fulfill the requirements for specific cases.

A NG-CN generally consists of various network functions, including Access and Mobility Function (AMF), Session Management Function (SMF), Policy Control Function (PCF), Application Function (AF), Authentication Server Function (AUSF), User Plane Function (UPF), and User Data Management (UDM), wherein each network function may be implemented as a network element on a dedicated hardware, or as a software instance running on a dedicated hardware, or as a virtualized function instantiated on an appropriate platform, e.g., a cloud infrastructure. In addition, a NG-CN may include an IMS for providing IP multimedia services, such as Voice over NR (VoNR) call services for both normal calls and emergency calls, and an LCS server for providing location services.

The AMF provides UE-based authentication, authorization, mobility management, etc. The SMF is responsible for session management and allocates Internet Protocol (IP) addresses to UEs. It also selects and controls the UPF for data transfer. If a UE has multiple sessions, different SMFs may be allocated to each session to manage them individually and possibly provide different functions per session. The AF provides information on the packet flow to PCF responsible for policy control in order to support Quality of Service (QoS). Based on the information, the PCF determines policies about mobility and session management to make the AMF and the SMF operate properly. The AUSF stores data for authentication of UEs, while the UDM stores subscription data of UEs.

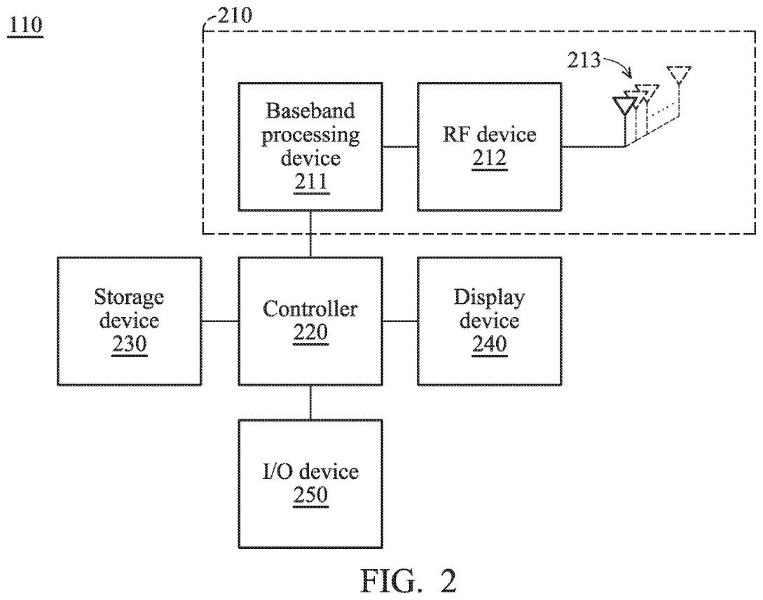

FIG. 2 is a block diagram illustrating the mobile communication device 110 according to an embodiment of the application.

As shown in FIG. 2, the mobile communication device 110 may include a wireless transceiver 210, a controller 220, a storage device 230, a display device 240, and an Input/Output (I/O) device 250.

The wireless transceiver 210 is configured to perform wireless transmission and reception to and from the access network 121.

Specifically, the wireless transceiver 210 may include a baseband processing device 211, a Radio Frequency (RF) device 212, and antenna 213, wherein the antenna 213 may include an antenna array for beamforming.

The baseband processing device 211 is configured to perform baseband signal processing and control the communications between subscriber identity card(s) (not shown) and the RF device 212. The baseband processing device 211 may contain multiple hardware components to perform the baseband signal processing, including Analog-to-Digital Conversion (ADC)/Digital-to-Analog Conversion (DAC), gain adjusting, modulation/demodulation, encoding/decoding, and so on.

The RF device 212 may receive RF wireless signals via the antenna 213, convert the received RF wireless signals to baseband signals, which are processed by the baseband processing device 211, or receive baseband signals from the baseband processing device 211 and convert the received baseband signals to RF wireless signals, which are later transmitted via the antenna 213. The RF device 212 may also contain multiple hardware devices to perform radio frequency conversion. For example, the RF device 212 may comprise a mixer to multiply the baseband signals with a carrier oscillated in the radio frequency of the supported cellular technologies, wherein the radio frequency may be 900 MHz, 2100 MHz, or 2.6 GHz utilized in the LTE/LTE-A/TD-LTE technology, or may be any radio frequency (e.g., 30 GHz-300 GHz for mmWave) utilized in the 5G NR technology, or another radio frequency, depending on the cellular technology in use.

The controller 220 may be a general-purpose processor, a Micro Control Unit (MCU), an application processor, a Digital Signal Processor (DSP), a Graphics Processing Unit (GPU), a Holographic Processing Unit (HPU), a Neural Processing Unit (NPU), or the like, which includes various circuits for providing the functions of data processing and computing, controlling the wireless transceiver 210 for wireless communication with the access network 121, storing and retrieving data (e.g., program code) to and from the storage device 230, sending a series of frame data (e.g. representing text messages, graphics, images, etc.) to the display device 240, and receiving user inputs or outputting signals via the I/O device 250.

In particular, the controller 220 coordinates the aforementioned operations of the wireless transceiver 210, the storage device 230, the display device 240, and the I/O device 250 for performing the methods for reliable transmission of a SUPL INIT message.

In another embodiment, the controller 220 may be incorporated into the baseband processing device 211, to serve as a baseband processor.

As will be appreciated by persons skilled in the art, the circuits of the controller 220 will typically include transistors that are configured in such a way as to control the operation of the circuits in accordance with the functions and operations described herein. As will be further appreciated, the specific structure or interconnections of the transistors will typically be determined by a compiler, such as a Register Transfer Language (RTL) compiler. RTL compilers may be operated by a processor upon scripts that closely resemble assembly language code, to compile the script into a form that is used for the layout or fabrication of the ultimate circuitry. Indeed, RTL is well known for its role and use in the facilitation of the design process of electronic and digital systems.

The storage device 230 may be a non-transitory machine-readable storage medium, including a memory, such as a FLASH memory or a Non-Volatile Random Access Memory (NVRAM), or a magnetic storage device, such as a hard disk or a magnetic tape, or an optical disc, or any combination thereof for storing data, instructions, and/or program code of applications, communication protocols (e.g., communication protocols for LTE, SIP, and SUPL), and/or the methods of the present application. For example, the methods of the present application may be implemented as part of the communication protocols for LTE, SIP, and/or SUPL.

The display device 240 may be a Liquid-Crystal Display (LCD), a Light-Emitting Diode (LED) display, an Organic LED (OLED) display, or an Electronic Paper Display (EPD), etc., for providing a display function. Alternatively, the display device 240 may further include one or more touch sensors disposed thereon or thereunder for sensing touches, contacts, or approximations of objects, such as fingers or styluses.

The I/O device 250 may include one or more buttons, a keyboard, a mouse, a touch pad, a video camera, a microphone, and/or a speaker, etc., to serve as the Man-Machine Interface (MMI) for interaction with users.

It should be understood that the components described in the embodiment of FIG. 2 are for illustrative purposes only and are not intended to limit the scope of the application.

For example, the mobile communication device 110 may include more components, such as a power supply, and/or a Global Positioning System (GPS) device, wherein the power supply may be a mobile/replaceable battery providing power to all the other components of the UE, and the GPS device may provide the location information of the UE for use by some location-based services or applications. Alternatively, the mobile communication device 110 may include fewer components. For example, the UE may not include the display device 240 and/or the I/O device 250.

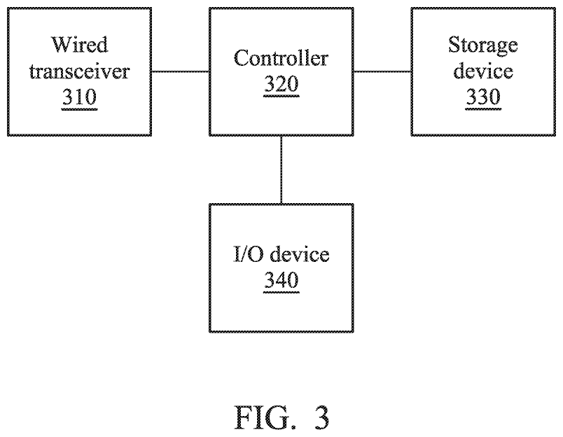

FIG. 3 is a block diagram illustrating a network entity according to an embodiment of the application.

As shown in FIG. 3, a network entity (e.g., CSCF or SLP) may include a wired transceiver 310, a controller 320, a storage device 330, and an I/O device 340.

The wired transceiver 310 is configured to provide wired communications with other network entities in the core network 122.

For example, the wired transceiver 310 may include a cable modem, an Asymmetric Digital Subscriber Line (ADSL) modem, a Fiber-Optic Modem (FOM), and/or an Ethernet interface.

The controller 320 may be a general-purpose processor, an MCU, application processor, DSP, GPU, HPU, NPU, or the like, which includes various circuits for providing the functions of data processing and computing, controlling the wired transceiver 310 for wired communications with other network entities in the core network 122, storing and retrieving data (e.g., program code) to and from the storage device 330, and receiving user inputs or outputting signals via the I/O device 340.

In particular, the controller 320 coordinates the aforementioned operations of the wired transceiver 310, the storage device 330, and the I/O device 340 for performing the methods for reliable transmission of a SUPL INIT message.

As will be appreciated by persons skilled in the art, the circuits of the controller 320 will typically include transistors that are configured in such a way as to control the operation of the circuits in accordance with the functions and operations described herein. As will be further appreciated, the specific structure or interconnections of the transistors will typically be determined by a compiler, such as an RTL compiler. RTL compilers may be operated by a processor upon scripts that closely resemble assembly language code, to compile the script into a form that is used for the layout or fabrication of the ultimate circuitry. Indeed, RTL is well known for its role and use in the facilitation of the design process of electronic and digital systems.

The storage device 330 may be a non-transitory machine-readable storage medium, including a memory, such as a FLASH memory or a NVRAM, or a magnetic storage device, such as a hard disk or a magnetic tape, or an optical disc, or any combination thereof for storing data, instructions, and/or program code of applications, communication protocols (e.g., communication protocols for LTE, SIP, and SUPL), and/or the methods of the present application. For example, the methods of the present application may be implemented as part of the communication protocols for LTE, SIP, and/or SUPL.

The I/O device 340 may include one or more buttons, a keyboard, a mouse, a touch pad, a video camera, a microphone, and/or a speaker, etc., to serve as the MMI for interaction with users.

It should be understood that the components described in the embodiment of FIG. 3 are for illustrative purposes only and are not intended to limit the scope of the application.

For example, a network entity (e.g., CSCF or SLP) may include more components, such as a power supply, and/or a display device, wherein the power supply may be a mobile/replaceable battery providing power to all the other components of the cellular station, and the display device may be an LCD/LED/OLED/EPD for providing a di splay function.

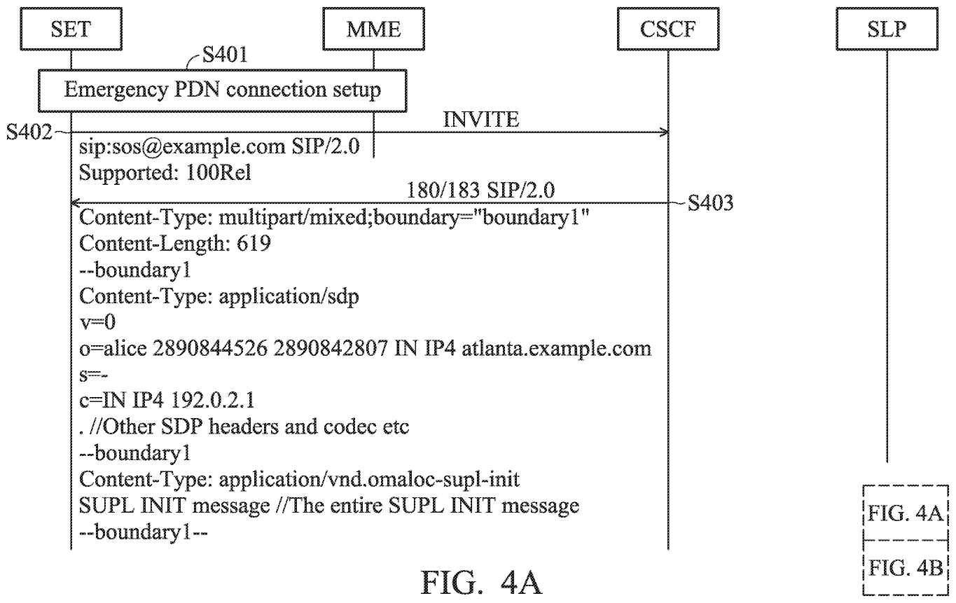

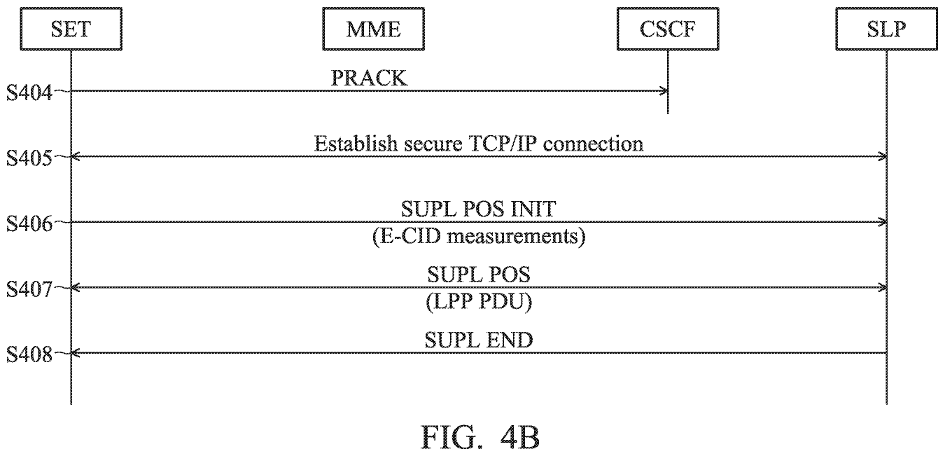

FIGS. 4A and 4B show a message sequence chart illustrating a method for reliable transmission of a SUPL INIT message according to an embodiment of the application.

To begin with, the SET (e.g., the mobile communication device 110) establishes a PDN connection with the MME for an emergency call (step S401).

Next, the SET sends an INVITE request for the emergency call to the CSCF entity (step S402).

Specifically, the INVITE request may include a service Uniform Resource Name (URN) with a service type of “sos” to indicate emergency services. In addition, the INVITE request may include information (e.g., an “100Rel” option tag in the Require header field) indicating that the SET supports reliable transmission.

Subsequent to step S402, the CSCF entity replies to the SET with a response to the INVITE request, wherein the response includes an SUPL INIT message (step S403).

Specifically, the response may be a 180 response or a 183 response used in the Session Initiation Protocol (SIP). The SUPL INIT message may be prepared by an SLP for initiating a SUPL session with the SET, and the SUPL INIT message may be included in the multipart body of the 180 response or the 183 response, along with the audio/video media Session Description Protocol (SDP).

Subsequent to step S404, after receiving the response, the SET sends an acknowledgement of the response to the CSCF entity (step S404).

Specifically, the acknowledgement may be a PRACK request message incompliance with SIP.

Please note that, in this embodiment, reliable transmission of the SUPL INIT message is realized by using the SIP's offer answer model. In other words, the response to the INVITE request is a reliable SIP message, and the transmission of the SUPL INIT message becomes reliable due to the SUPL INIT message being sent in the multipart body of the response.

In the conventional practice, location tracking of the SET will not be triggered if the emergency call fails. By contrast, in the present application, real-time location tracking of the SET may be activated even when the emergency call fails.

Subsequent to step S404, the SET establishes a secure Transmission Control Protocol (TCP) or Internet Protocol (IP) connection with the SLP (step S405).

After the secure TCP/IP connection is established, the SET sends a SUPL POS INIT message to the SLP to initiate a positioning session with the SLP (step S406).

Specifically, the SUPL POS INIT message may include the SET capabilities, such as the supported positioning technologies (e.g., Enhanced Cell Identity (E-CID) measurements).

Subsequent to step S406, in response to the SET sending the SUPL POS INIT message, one or more SUPL POS messages is/are delivered between the SET and the SLP to exchange positioning procedure messages (e.g., LPP PDU) used to calculate the position of the SET (step S407).

After that, the SLP sends a SUPL END message to the SET to end the positioning session (step S408).

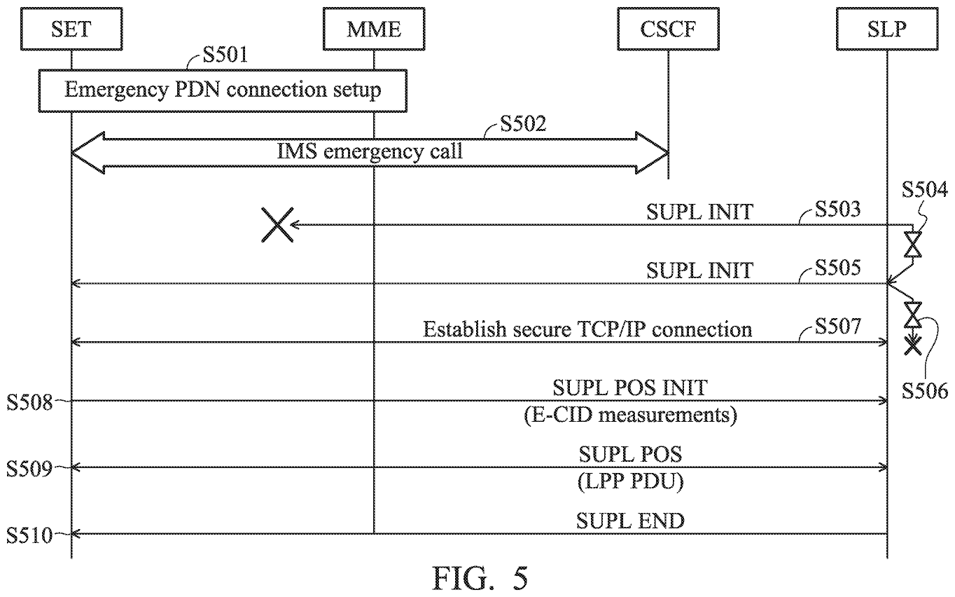

FIG. 5 is a message sequence chart illustrating a method for reliable transmission of a SUPL INIT message according to another embodiment of the application.

To begin with, the SET (e.g., the mobile communication device 110) establishes a PDN connection with the MME for an emergency call (step S501).

Next, the IMS emergency call is connected for the SET via the CSCF entity (step S502).

Subsequent to step S502, the SLP sends a SUPL INIT message to the SET (step S503), and starts a guard timer in response to sending the SUPL INIT message (step S504).

Subsequent to step S504, in response to the guard timer being expired and not receiving any TCP/IP connection request from the SET, the SLP resends the SUPL INIT message to the SET (step S505), and restart the guard timer (step S506).

Please note that, if no TCP/IP connection request is received from the SET before the guard timer expires, it means the transmission of the SUPL INIT message has failed. In response, the SLP will resend the SUPL INIT message to ensure the reliable transmission of the SUPL INIT message.

Subsequent to step S506, the SLP receives a TCP/IP connection request from the SET for establishing a secure TCP/IP connection and stops the guard timer in response to receiving the TCP/IP connection request (step S507).

After the secure TCP/IP connection is established, the SET sends a SUPL POS INIT message to the SLP to initiate a positioning session with the SLP (step S508).

Specifically, the SUPL POS INIT message may include the SET capabilities, such as the supported positioning technologies (e.g., E-CID measurements).

Subsequent to step S508, one or more SUPL POS messages is/are delivered between the SET and the SLP to exchange positioning procedure messages (e.g., LPP PDU) used to calculate the position of the SET (step S509).

After that, the SLP sends a SUPL END message to the SET to end the positioning session (step S510).

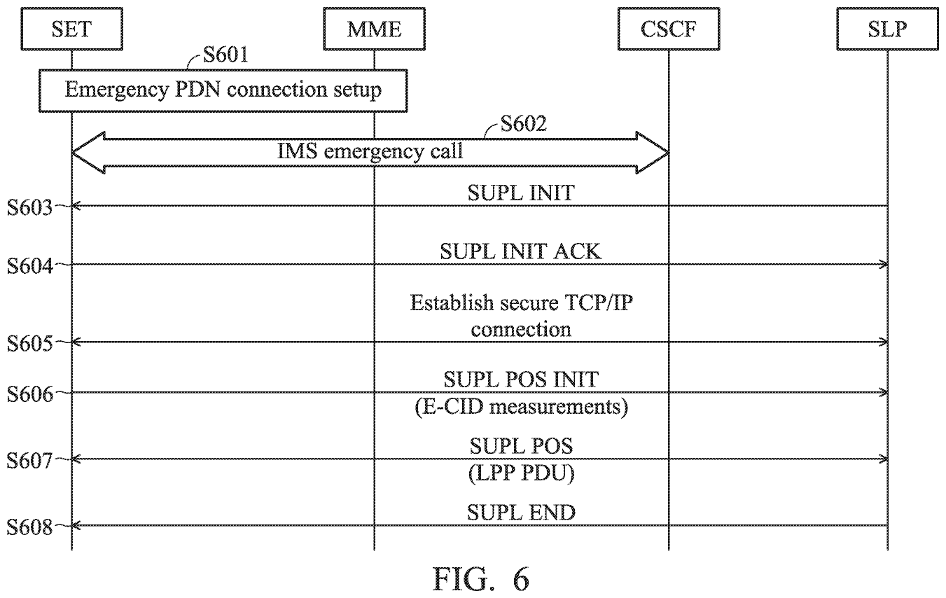

FIG. 6 is a message sequence chart illustrating a method for reliable transmission of a SUPL INIT message according to another embodiment of the application.

To begin with, the SET (e.g., the mobile communication device 110) establishes a PDN connection with the MME for an emergency call (step S601).

Next, the IMS emergency call is connected for the SET via the CSCF entity (step S602).

Subsequent to step S602, the SLP sends a SUPL INIT message to the SET (step S603).

Subsequent to step S603, the SET sends an acknowledgement of the SUPL INIT message to the SLP (step S604).

Specifically, the acknowledgement may be a SUPL INIT ACK message.

In another embodiment, the SLP may start a guard timer upon sending the SUPL INIT message, and if no acknowledgement is received from the SET before the guard timer expires, the SLP may resend the SUPL INIT message.

Please note that, in this embodiment, reliable transmission of the SUPL INIT message is realized by enabling the SET to acknowledge the reception of the SUPL INIT message and optionally enabling the SLP to start a guard timer to decide if it is required to resend the SUPL INIT message.

Subsequent to step S604, the SET establishes a secure TCP/IP connection with the SLP (step S605).

After the secure TCP/IP connection is established, the SET sends a SUPL POS INIT message to the SLP to initiate a positioning session with the SLP (step S606).

Specifically, the SUPL POS INIT message may include the SET capabilities, such as the supported positioning technologies (e.g., E-CID measurements).

Subsequent to step S606, in response to the SET sending the SUPL POS INIT message, one or more SUPL POS messages is/are delivered between the SET and the SLP to exchange positioning procedure messages (e.g., LPP PDU) used to calculate the position of the SET (step S607).

After that, the SLP sends a SUPL END message to the SET to end the positioning session (step S608).

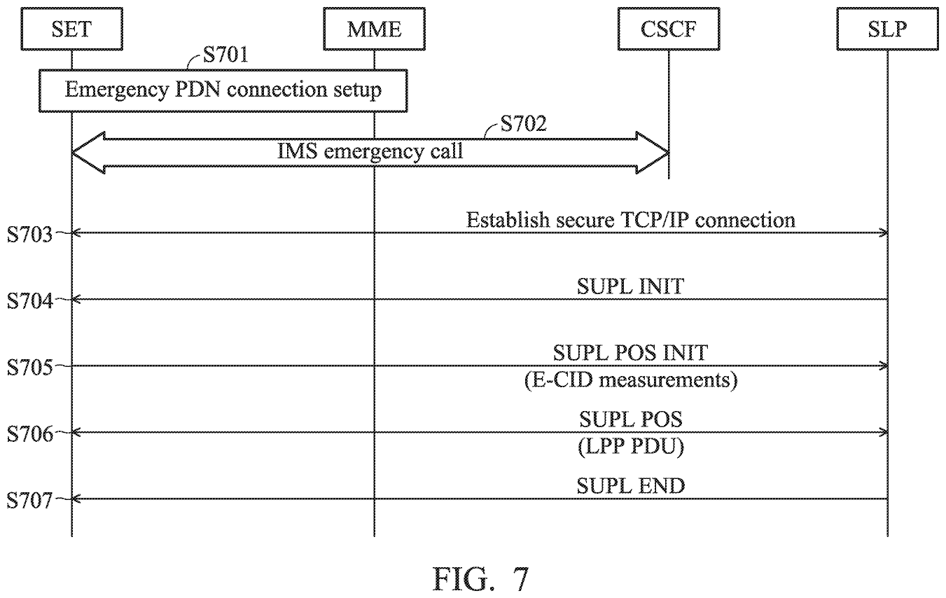

FIG. 7 is a message sequence chart illustrating a method for reliable transmission of a SUPL INIT message according to another embodiment of the application.

To begin with, the SET (e.g., the mobile communication device 110) establishes a PDN connection with the MME for an emergency call (step S701).

Next, the IMS emergency call is connected for the SET via the CSCF entity (step S702).

Subsequent to step S702, the SET establishes a secure TCP/IP connection with the SLP (step S703).

After the secure TCP/IP connection is established, the SLP sends a SUPL INIT message to the SET (step S704).

Please note that, in this embodiment, reliable transmission of the SUPL INIT message is realized by postponing the transmission of the SUPL INIT message until the secure TCP/IP connection is established between the SET and the SLP.

Subsequent to step S704, the SET sends a SUPL POS INIT message to the SLP to initiate a positioning session with the SLP (step S705).

Specifically, the SUPL POS INIT message may include the SET capabilities, such as the supported positioning technologies (e.g., E-CID measurements).

Subsequent to step S705, in response to the SET sending the SUPL POS INIT message, one or more SUPL POS messages is/are delivered between the SET and the SLP to exchange positioning procedure messages (e.g., LPP PDU) used to calculate the position of the SET (step S706).

After that, the SLP sends a SUPL END message to the SET to end the positioning session (step S707).

In view of the forgoing embodiments, it should be appreciated that the present application realize reliable transmission of the SUPL INIT message by including the SUPL INIT message in the SIP 180/183 response, or enabling the SLP to resend the SUPL INIT message when a guard timer expires, or enabling the SET to acknowledge the reception of the SUPL INIT message, or postponing the transmission of the SUPL INIT message until the secure TCP/IP connection is established between the SET and the SLP. Advantageously, the location tracking service may function normally for IMS emergency calls.

While the application has been described by way of example and in terms of preferred embodiment, it should be understood that the application is not limited thereto. Those who are skilled in this technology can still make various alterations and modifications without departing from the scope and spirit of this application. Therefore, the scope of the present application shall be defined and protected by the following claims and their equivalents.

What is claimed is:

1. A method, executed by a SUPL (Secure User Plane Location) Enabled Terminal (SET), comprising:
sending an INVITE request for an emergency call to a Call Session Control Function (CSCF) entity of an IP Multimedia Subsystem (IMS); and
receiving a response to the INVITE request from the CSCF entity, wherein the response comprises an SUPL INIT message.

2. The method of claim 1, wherein the SUPL INIT message is prepared by a SUPL Location Platform (SLP) for initiating a SUPL session with the SET.

3. The method of claim 2, further comprising:
establishing a Transmission Control Protocol (TCP) or Internet Protocol (IP) connection with the SLP;
sending a SUPL POS INIT message to the SLP to initiate a positioning session with the SLP, after establishing the TCP or IP connection;
sending or receiving a SUPL POS message to or from the SLP to exchange positioning procedure messages used to calculate the position of the SET, in response to sending the SUPL POS INIT message; and
receiving a SUPL END message from the SLP after sending or receiving the SUPL POS message.

4. The method of claim 1, wherein the INVITE request comprises information indicating that the SET supports reliable transmission, and the method further comprises:
sending an acknowledgement of the response to the CSCF entity.

5. The method of claim 1, wherein the response is a 180 response or a 183 response used in Session Initiation Protocol (SIP), and the SUPL INIT message is comprised in a multipart body of the 180 response or the 183 response.

6. A method, executed by a Call Session Control Function (CSCF) entity of an IP Multimedia Subsystem (IMS), comprising:
sending a SUPL (Secure User Plane Location) INIT message to a SUPL (Secure User Plane Location) Enabled Terminal (SET);
starting a timer in response to sending the SUPL INIT message; and
resending the SUPL INIT message to the SET in response to the timer being expired and not receiving any Transmission Control Protocol (TCP) or Internet Protocol (IP) connection request from the SET.

7. The method of claim 6, further comprising:
stopping the timer in response to receiving a TCP or IP connection request from the SET.

8. The method of claim 6, further comprising:
establishing a TCP or IP connection with the SET in response to receiving a TCP or IP connection request from the SET;
receiving a SUPL POS INIT message from the SET for initiating a positioning session, after establishing the TCP or IP connection;
sending or receiving a SUPL POS message to or from the SET to exchange positioning procedure messages used to calculate the position of the SET, in response to receiving the SUPL POS INIT message; and
sending a SUPL END message to the SET after sending or receiving the SUPL POS message.

9. A method, executed by a SUPL (Secure User Plane Location) Enabled Terminal (SET), comprising:
receiving a SUPL INIT message from a SUPL Location Platform (SLP); and
sending an acknowledgement of the SUPL INIT message to the SLP in response to receiving the SUPL INIT message.

10. The method of claim 9 wherein the acknowledgement is a SUPL INIT ACK message.

11. The method of claim 9, further comprising:
establishing a Transmission Control Protocol (TCP) or Internet Protocol (IP) connection with the SLP;
sending a SUPL POS INIT message to the SLP to initiate a positioning session with the SLP, after establishing the TCP or IP connection;
sending or receiving a SUPL POS message to or from the SLP to exchange positioning procedure messages used to calculate the position of the SET, in response to sending the SUPL POS INIT message; and
receiving a SUPL END message from the SLP after sending or receiving the SUPL POS message.

12. A method, executed by a SUPL (Secure User Plane Location) Enabled Terminal (SET), comprising:
establishing a Transmission Control Protocol (TCP) or Internet Protocol (IP) connection with a SUPL Location Platform (SLP); and
receiving a SUPL INIT message from the SLP after establishing the TCP or IP connection.

13. The method of claim 12, further comprising:
sending a SUPL POS INIT message to the SLP to initiate a positioning session with the SLP in response to receiving the SUPL INIT message;
sending or receiving a SUPL POS message to or from the SLP to exchange positioning procedure messages used to calculate the position of the SET, in response to sending the SUPL POS INIT message; and
receiving a SUPL END message from the SLP after sending or receiving the SUPL POS message.
